(19) United States
(12) Patent Application Publication
(10) Pub. No.: US 2004/0226580 A1
(43) Pub. Date: Nov. 18, 2004

(54) Method of flushing a coil pipe(s) of a heat exchanger

(76) Inventor: Tadashi Shiraishi, Shibuya-ku (JP)

Correspondence Address: JORDAN AND HAMBURG LLP, 122 EAST 42ND STREET, SUITE 4000, NEW YORK, NY, 10168, US

(21) Appl. No.: 10/699,136

(22) Filed: Oct. 31, 2003

(30) Foreign Application Priority Data
May 14, 2003 (JP) 2003-135595

(51) Int. Cl. B08B 9/00

(52) U.S. Cl. 134/22.1

(57) ABSTRACT

A heat exchanger coil pipe is internally cleaned off dirt deposits by forcing ice and water to pass the pipe. A system for carrying out the cleaning comprises a suction pump, a wastewater collecting tank, a suction hose for connection between the waste and wash water collecting tank and a heat transfer medium inlet or outlet of the pipe and an ice-feeding hose provided at one end with a hopper and connectable at the other end to the heat transfer medium outlet or inlet pipe. In the state of the suction hose being connected to the heat transfer medium inlet or outlet and the suction hose being connected to the heat transfer medium outlet or inlet, ice and water are supplied from the hopper and drawn into the ice by suction from the suction pump to flow in the coil pipe and collected into the wastewater collecting tank.

### BACKGROUND OF THE INVENTION

The present invention relates to a method of cleaning the inside of a coil pipe(s) of a heat exchanger and, more specifically, to a method of cleaning the inside of the cooling coil pipe(s) or heating coil pipe(s) of the heat exchanger by forcing water and ice to flow in the coil pipe(s) for removing off dirt deposits such as slime, sludge and residue.

As well known, a heat exchanger transfers heat from a heat transfer medium (e.g., water or steam) passing through in a coil pipe(s) to other medium (e.g., air or water) flowing along the outside of the coil pipe(s) to cool or heat the latter. Dirt deposited in the coil pipe(s) results in a decrease in working efficiency of the heat exchanger. For example, the decreased cooling or heating ability of air conditioners is resulted in most cases from dirt deposits in the cooling or heating coil pipe(s). Namely, the dirt deposited in the coil pipe(s) may prevent the heat exchange between the heating or cooling medium flowing therein and the air flowing along the outside of the coil pipe(s). The buildup of slime, sludge and residue in the coil pipe(s) may also reduce the passage of heat transfer medium (cold or hot water in case of air conditioner) in the coil pipe(s), resulting in lowering the flow rate of the medium flowing therein than the nominal value necessary for achieving designed temperature difference between two fluids cannot be achieved.

For example, a cooling coil pipe(s) or heating coil pipe(s) of a heat exchanger (for chilled or hot water) of an air conditioner may be severely fouled in 10-15 years' use. This results in lowered cooling or heating capacity and shortening the service life of the device. To recover the capacity of the air conditioner, it is usually conducted to increase the airflow rate, wash the fin side (air side) of the heat exchanger coil pipe(s) with high-pressure water and, in rare cases, clean the inside of the heat exchanger coil pipe(s) (heat transfer side) with cleaning agent.

As described above, a heat exchanger coil pipe(s) is usually cleaned by washing its outside wall (air side) and, in rare cases, by flushing its inside wall (water side) with chemical solution. With regard to waste piping, the present applicant has proposed washing the inside of waste pipes with ice cubes in Japanese Patent Publication No. 1-28625.

However, the use of cleaning chemicals is accompanied by a risk of corroding the inside wall of the heat exchanger coil pipe(s) and polluting the environment with waste solution containing residue of chemicals. Therefore, there has been desired a method of cleaning the inside of heat exchanger coil pipe(s), which is friendly both to the heat exchanger coil pipe(s) and the ecological environment. The present invention is directed to a cleaning method that can satisfy the above-described requirements.

### SUMMARY OF THE INVENTION

An object of the present invention is to provide a method of cleaning the inside of a heat exchanger coil pipe(s), which comprises a suction pump, a waste water collecting tank, a suction hose for connection between a heat transfer medium inlet or outlet of the heat exchanger coil pipe(s) and an inlet port of the waste water collecting tank and an ice supply hose provided at its one end with a hopper and connected at its other end to the outlet or inlet of the heat exchanger coil pipe(s), whereby the inside of the coil pipe(s) is cleaned with ice and water supplied thereto from the hopper through the ice supply hose, which by suction from the suction pump passes through the coil pipe(s) and enters into the waste water collecting tank.

Another object of the present invention is to provide a method of cleaning the inside of a heat exchanger coil pipe(s), whereby the cleaning is repeated in reverse direction by exchanging the connection of the inlet or outlet of the coil pipe(s) to the suction hose for the connection to the ice supply hose and by supplying ice and water into the coil pipe(s) and collecting the waste into the tank.

Another object of the present invention is to provide a method of cleaning the inside of a heat exchanger coil pipe(s), wherein the waste-and-wash water passing the heat exchanger coil pipe(s) is visually monitored in the transparent portion of the ice supply hose.

Another object of the present invention is to provide a method of cleaning the inside of a heat exchange coil pipe(s), whereby a mixture of ice and water, prepared in the ratio of 1 (ice) to 4˜6 (water), is supplied from the hopper into the coil pipe(s).

Another object of the present invention is to provide a method of cleaning the inside of a heat exchange coil pipe(s), whereby ice is prepared in form of cubes each having a side length corresponding to ⅓-⅔ of an inner diameter of the coil pipe(s) to be cleaned.

### BRIEF DESCRIPTION OF THE DRAWINGS

FIG. 1 is a view for explaining an example of a system for cleaning the inside of heat exchanger coil pipe(s), which carries out the cleaning method according to the present invention when cleaning the inside of a heat exchanger coil pipe(s) of an air conditioner.

FIG. 2 is a perspective view of connections of a cleaning system with a heat exchanger coil pipe(s).

FIG. 3 shows an example of a flow of washing water through a heat exchanger coil pipe(s).

FIG. 4 shows an example of a reversed flow of washing water through a heat exchanger coil pipe(s).

FIG. 5 shows an example of arrangement of a coil pipe(s) of a heat exchanger.

### PREFERRED EMBODIMENT OF THE INVENTION

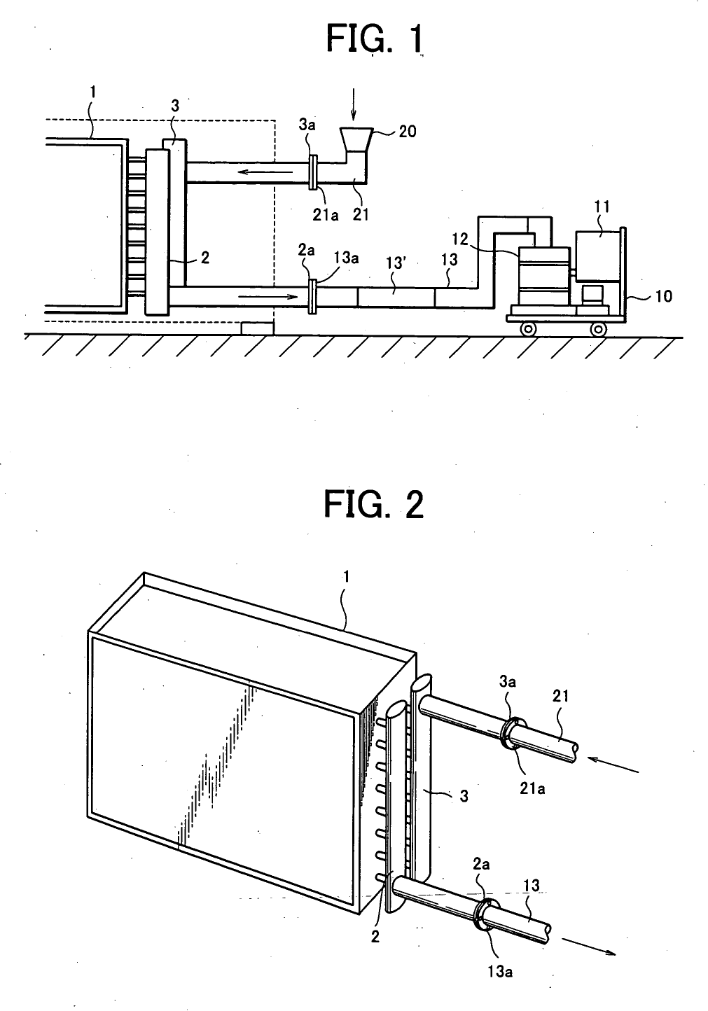

FIG. 1 illustrates an essential portion of a system for carrying out the method of the present invention for cleaning the inside of a heat exchanger coil pipe(s). The method of the present invention will be described by way of example and with reference to FIG. 1 when it is applied to the cleaning of a heat exchanger coil pipe(s) of an air conditioner. However, this method is not limited to the cleaning of the air conditioner coil pipe(s) (for heat transfer between water and air) and can be applied to heat exchanger coil pipe(s) for transferring heat from water to water, steam to water, steam to air. In FIG. 1, there is shown an air conditioner (heat exchanger) 1 having a heat exchanger coil pipe(s), a header 2 for supplying heat transfer medium (chilled water or hot water) into the heat exchanger coil pipe(s) of the air conditioner 1 and a discharging header 3 for discharging the heat transfer medium having passed the heat exchanger coil pipe(s) of the air conditioner. The air-conditioner 1 and the headers 2 and 3 are installed in a building. For example, the air-conditioner 1 is provided with at its rear side a fan for creating a stream of air from the rear side to the front side across the heat exchanger coil pipe(s) in which heat transfer medium (chilled water or hot water) flows. The air is deprived of heat or given heat by the heat transfer medium (chilled water or hot water) through the outside wall of the coil pipe(s). The stream of cooled or warmed air is thus supplied from the air conditioner.

The present invention relates to a method of cleaning the inside of a heat exchanger coil pipe(s) as described above. In FIG. 1, there is shown a carriage 10 on which a suction pump 11 and a waste-and-wash water collecting tank 12 are mounted, and a hopper 20 for feeding ice and water. A heat transfer medium feeding pipe (not shown) and a heat transfer medium discharging pipe (not shown) are disconnected from an inlet 2a of the header 2 and an outlet 3a of the header 3 respectively. As shown in FIG. 2, in place of the removed pipes, a suction end 13a of a suction hose 13 is connected to the heat transfer medium (chilled or hot water) feeding inlet 2a of the header 2 and an ice-water feeding end 21a of the ice-and-water feeding hose 21 is connected to a heat transfer medium discharging port 3a of the header 3.

On completion of the connections of the cleaning system as shown in FIG. 1, the suction pump 11 is driven and, ice and water are supplied into the hopper 20. The mixture of ice and water flows through the feeding pipe 21 and the header 3 into the heat exchanger coil pipe(s) of the air conditioner 1, wherein slime, sludge and residual matters deposited on the inner wall of the coil pipe(s) are removed by impact energy of ice cubes and the force of water and washed away together with the ice and water through the header 2 and the suction hose 13 into the waste-and-wash water collecting tank 12.

As described above, according to the present invention, the ice and water (ice only, water only or a mixture of ice and water may be used in practical cases) is forced by suction from the suction pump to flow through the heat exchanger coil pipe(s) in which rust, fur and slime deposited on the inner wall of the coil pipe(s) are removed off by the impact of collision of ice cubes therewith and washed out by water stream together with sludge (dust and sand), weld slugs and pipe-cut chips remaining in the coil pipe(s).

As described above, according to the present invention, it is possible to:

(1) softly clean the inside of a heat exchanger coil pipe(s) with ice and water;

(2) remove dirt such as rust, fur and slime from the inner wall of the coil pipe(s);

(3) remove sludge such as dust and sand from the inside of the coil pipe(s); and

(4) remove residues such as welding and cutting chips from the inside of the coil pipe(s).

The cleaning method according to the present invention offers the following advantages:

(1) The inside of the coil pipe(s) can be softly washed with ice and water with no fear of damaging the inner wall of the coil pipe(s) (ice is softer than copper of which most of coil pipe(s) are made);

(2) There is no fear of accident by spouting of waste and rapture of the coil pipe(s) owing to a negative pressure in the coil pipe(s);

(3) Washing with ice and water does not pollute the environments;

(4) The method can be applied to old type heat exchangers which may be easily damaged and troubled with an increased leakage from pinholes and cracks when forcibly cleaning by other conventional methods. This method does not cause such a trouble.

The results of experiments indicate that a mixture of ice and water, which was prepared in ratio of 1 (ice): 5 (water), is suitable and the suitable size (one side length) of an ice cube corresponds to ⅓˜⅔ of the inside diameter of a coil pipe(s) to be internally washed (for example, if the inside diameter of the coil pipe(s) is 150 mm, it is recommended to prepare ice cubes each having a side length of 5 to 10 mm).

The suction hose 13 having a transparent portion 13′ through which the dirty degree of waste-and-wash water can be visually observed to easily judge the result of cleaning.

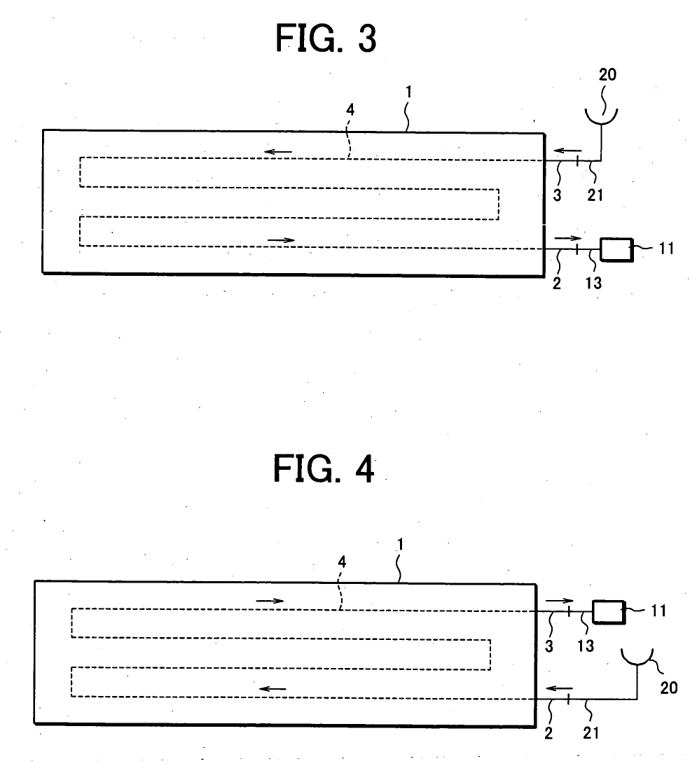

After cleaning the inside of the coil pipe(s) in the condition shown in FIG. 1 (by the flow of the mixture of ice and water in the direction shown by arrows in FIG. 3), the suction hose 13 is connected to the header 3, the feeding hose 21 is connected to header 2, a mixture of ice and water is put into the hopper 20 and then the suction pump 11 is driven into operation. In this case, as shown in FIG. 4, the ice and water flow in the coil pipes 4 in the direction reverse to that in the previous cleaning as shown in FIG. 3. This reverse flushing can effectively clean the inside of the coil pipes 4. It is effective to repeat the above-described washing of the inside of the coil pipes 4 several times as necessary by alternately reversing the flow direction, i.e., in the directions reverse to each other as shown in FIGS. 3 and 4. By doing so, the inside of the coil pipes 4 can be further effectively cleaned.

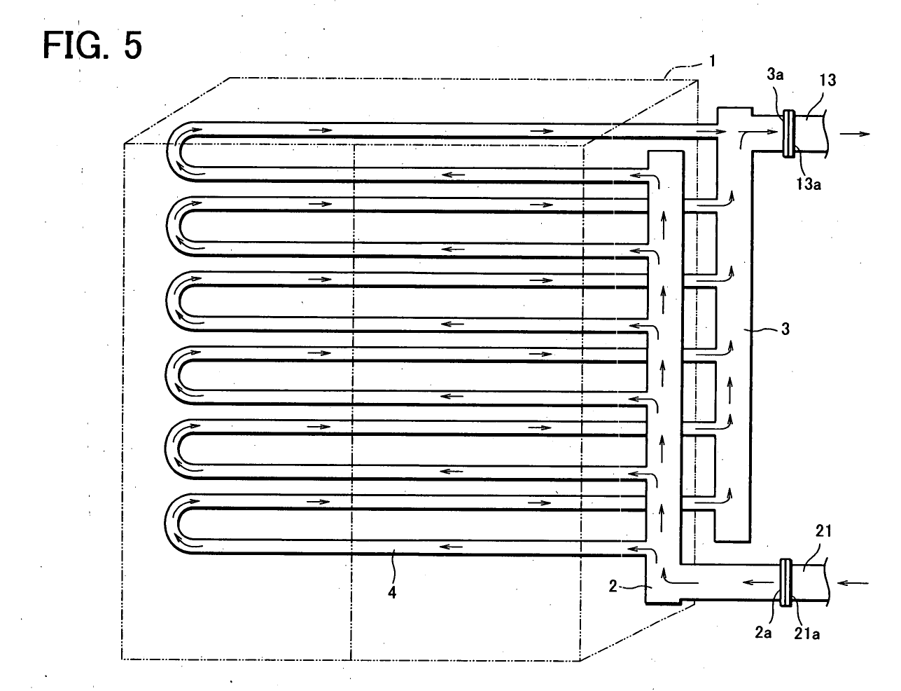

FIG. 5 shows an example of arrangement of a heat exchanger coil pipes 4 in an air conditioner 1 with arrows indicating how the mixture of ice and water flows in the coil pipes 4.

While washing the inside of coil pipes 4, the inner wall of the coil pipes 4 cannot be damaged by ice cubes since ice is softer than the copper coil pipes 4 and water can serves as lubricant. High negative pressure (vacuum) is created in the inside of the coil pipes by suction from the suction pump to achieve effective flushing with ice and water, removing dirt deposits from the inside wall of the coil pipes 4. The sticky dirt deposits can be washed away by repeating several times flushing with ice and water alternating the flushing direction, i.e., from the top to the bottom of the coil pipe and from the bottom to the top thereof.

1. A method of cleaning the inside of a coil pipe(s) of a heat exchanger, which is carried out by a system comprising a suction pump, a waste-and-wash water collecting tank, a suction hose for connection between the waste-and-wash water collecting tank and a heat transfer medium inlet or outlet of the heat exchanger coil pipe(s) and an ice-feeding hose provided at one end with a hopper and connectable at the other end to the heat transfer medium outlet or inlet of the coil pipe(s), wherein in the state of the suction hose being connected to the heat transfer medium inlet or outlet of the coil pipe(s) and the suction hose being connected to the heat transfer medium outlet or inlet of the coil pipe(s), ice and water are supplied from the hopper and drawn into the coil pipe(s) by suction from the suction pump to pass through the inside of the coil pipe(s) and collected into the waste-and-wash water collecting tank.

2. A method of cleaning the inside of a coil pipe(s) of a heat exchanger as described in claim 1, wherein the process of supplying ice and water and collecting the waste and wash water is repeated by exchanging the connection of the suction hose to the inlet or outlet of the coil pipe(s) for the connection of the ice feeding hose to the outlet or inlet of the coil pipe(s).

3. A method of cleaning the inside of a coil pipe(s) of a heat exchanger as described in any of claims 1 and 2, wherein the ice feeding hose has a transparent portion through which a flow of waste-and-wash water can be visually observed.

4. A method of cleaning the inside of a coil pipe of a heat exchanger as described in any one of claims 1 and 2, wherein ice and water are mixed in ratio of 1 (ice) to 4˜6 (water).

5. A method of cleaning the inside of a coil pipe of a heat exchanger as described in any one of claims 1 and 2, wherein ice is prepared in the form of a cube whose side length corresponds to about ⅓-⅔ of an inside diameter of a heat exchanger coil pipe to be internally cleaned.
